(19) United States
(12) Patent Application Publication
(10) Pub. No.: US 2002/0129891 A1
(43) Pub. Date: Sep. 19, 2002

(54) Containers

(76) Inventor: Wayne John Harrison, Auckland (NZ)

Correspondence Address: STETINA BRUNDA GARRED & BRUCKER, 75 ENTERPRISE, SUITE 250, ALISO VIEJO, CA, 92656, US

(21) Appl. No.: 09/981,388

(22) Filed: Oct. 17, 2001

Related U.S. Application Data
(63) Continuation-in-part of application No. 09/381,435, filed on Sep. 16, 1999, now abandoned.
Application No. 09/381,435 is a 371 of international application No. PCT/NZ98/00036, filed on Mar. 16, 1998.

(51) Int. Cl. B31F 1/22

(52) U.S. Cl. 156/207; 156/272.6

(57) ABSTRACT

The present invention relates to a method of forming a laminated material comprising the steps of corrugating a paper sheet and applying a liner to one or both sides of the corrugated sheet, wherein the liner is a pre-made laminate of a paper backing and plastic film which is metalized on one side and corona or chemically treated on the other side. A laminating apparatus for use in the above method is also described herein, which includes a means for feeding out a paper sheet and a liner to a set of corrugating rollers, the liner being a pre-formed laminate of paper and plastics film, and means for uniting the paper sheet and liner immediately subsequently to the corrugation of the paper sheet.

### CROSS-REFERENCE TO RELATED APPLICATIONS

The present application is a continuation-in-part of U.S. application Ser. No. 09/381,435 entitled IMPROVEMENTS IN OR RELATING TO CONTAINERS filed Sep. 16, 1999 which claims priority to PCT/NZ98/00036 entitled PROCESS AND DEVICE FOR MAKING A CORRUGATED SHEET FOR CONTAINERS filed on Mar. 16, 1998.

### STATEMENT RE: FEDERALLY SPONSORED RESEARCH/DEVELOPMENT

(Not Applicable)

### BACKGROUND OF THE INVENTION

The present invention relates generally to containers and, more particularly, to containers used for transportation and storage of chilled or frozen foods. Preferably the present invention may be employed to create a corrugated product which is laminated with a metalized liner to improve the insulative properties of the corrugated product produced. Preferably this corrugated product may be produced in a single ‘in-line’ process which both corrugates a stock card material and laminates the metalized liner immediately subsequent to corrugation.

Chilled or frozen foods are commonly packed in insulated containers. In one example, expanded foams are commonly used for providing insulation properties. The material, however, has low impact resistance and is not generally regarded as having sufficient structural integrity for packaging applications and, as a result, the foam is often protected by an outside box. In addition, expanded foams are not approved for food contact applications, and food within such containers consequently needs to be bagged or wrapped.

Metal foils are also used in packaging situations to provide insulation properties.

The use of expanded foam insulation materials in packaging is not regarded as ideal because the material is bulky and, in addition, there are recognized disposal problems. Metal foils present manufacturing problems and additional costs, as physical properties are not compatible with machinery and standard processing techniques and, consequently, tend to be used only for smaller, higher value items.

As an alternative packaging material, cardboard has good natural insulation qualities which can be improved if a board is laminated, lamination also improving strength. However, existing technology does not allow a laminated cardboard product which includes layers of metalized foil to be easily provided. In this instance, sheet laminating machines are normally used.

WO 90/06222 (Olvey) and EPO 319252 (Brownlee) describe types of sheet lamination machines. The teachings of these references are confined to plastic film, standing alone, being adhered to a pre-corrugated product via a molten polymer.

A problem identified by the applicants with sheet laminating machinery is the need for pre-corrugated product to be produced in large volumes before the lamination stage can be completed. Corrugated card must be initially formed, then allowed to cool and cure for a significant period of time before it can be laminated. This in effect makes the creation of such corrugated metal-lined products a slow, two stage process.

The applicant has determined that significant heat dissipation problems occur during the application of a continuous sheet of a metalized film to a corrugated card or substrate when trying to use existing lamination technologies to laminate a corrugated product immediately after it exits a set of corrugation rollers. More particularly, a significant amount of heat is present in the corrugated card or substrate as it exits the corrugation rollers. This high level of heat causes complications during the application of a layer of metalized film to one or both sides of the corrugated substrate due to the derogatory effects such heat level has on the adhesive traditionally used to unite the metalized film to the corrugated substrate. Indeed, the heat problems are magnified by the metalization of the laminate since the metal layer reflects, absorbs and re-radiates heat into the corrugated substrate or card as the adhesive bonds.

It is the applicant's contention that to date these heat dissipation problems have prevented the development of a manufacturing process and associated machinery which could produce metalized corrugated product once passed through the lamination of a metalized liner as a resulting product as the corrugated card exits the set of corrugation rollers.

Reference is also made in the Olvey specification to the provision of a corona treatment to the plastics laminate film which is to be applied to pre-corrugated card products. As the card to be laminated has been pre-corrugated, it has had a chance to cool down and cure after the corrugation process. The corona treatment applied or used with the film to be laminated is therefore provided to improve the adhesive qualities of the film to the pre-made corrugated card product.

An improved method of forming a metalized liner onto a corrugated product which addressed any or all of the above problems would be of advantage.

It is an object of the present invention to provide a method and apparatus for producing insulated containers with corrugated board as a core material.

Further aspects and advantages of the present invention will become apparent from the ensuing description which is given by way of example only.

### BRIEF SUMMARY OF THE INVENTION

According to one aspect of the present invention, there is provided a method of forming a laminated material including the steps of corrugating a paper sheet while applying a liner to at least one side of the corrugated paper sheet, said liner being a pre-made laminate of paper backing and a polyester film, said polyester film having a first side which is metalized and a second side which is corona treated.

The liner can include a biaxially oriented polyester film which is metalized on one side and corona treated on the other side.

According to a further aspect of the present invention, there is provided a method of forming a laminated material, including the steps of corrugating a paper sheet while applying a liner to at least one side of the corrugated paper sheet, said liner being a pre-made laminate of a paper backing and a polyester film, said polyester film being metalized on one side and chemically treated on the opposite side.

Preferably, the liner may incorporate a biaxially oriented polyester film which is metalized on one side and chemically treated on the opposite side.

The liner can be preheated prior to its application to the paper sheet.

The liner can be heated by heating rollers and adhered to the paper sheet using a corrugation adhesive.

According to a further aspect of the invention, there is provided a laminating apparatus including means for feeding out a paper sheet and a liner to a set of corrugating rollers, the liner being a pre-formed paper laminate of paper and plastic film, and means for uniting the paper sheet and liner subsequent to the corrugation of the paper sheet.

The apparatus can include means for pre-heating the paper sheet and liner prior to the same being fed to the corrugating rollers.

The apparatus may include means for feeding a second liner for lamination with the paper sheet.

The lamination of the paper sheet and liner with the second liner can be subsequent to the lamination of the paper sheet with the liner.

The lamination of the paper sheet and the liner with the second liner can be achieved with the assistance of a cluster of in-line pressure rollers.

The second liner can be a laminate of a plastics film and paper.

The paper used to form the laminate can be of various thicknesses and grades and within the definition of paper it is intended to include thicker semi-rigid paper sheets (cardboard) and recycled and composite sheet materials including cellulose fibers derived from a variety of materials.

In this instance, the novelty of the invention revolves around the corona or chemical treatment of the polyester film. The applicants believe that heat dissipation problems exist with the application of a continuous sheet of metalized polyester film using existing technology. A significant amount of heat is present in the card as it exits the corrugation rollers, which in combination with applying a layer of metal to one side of the card causes complications in the performance of an adhesive used to unite the two components. By corona or chemically treating one side of the polyester film, these heat problems are alleviated.

A major advantage of the present invention comes from manufacturing speed increases obtained through corrugating card product and applying the metalized layer at approximately the same time. With prior art metalized corrugated products, the metalized layer would need to be applied after the source card had been corrugated and heat cooled. This is commonly known as sheet laminating.

The present invention provides significant manufacturing advantages over prior art methods as it allows the application of a liner at the same time as the paper sheet is corrugated. This significantly speeds up and simplifies the manufacturing process which is normally a two step operation, as newly corrugated paper sheet must normally be allowed to cool before the liner can be applied.

The essence of the present invention relies on the particular characteristics of the film used in the manufacture of the metalized corrugated product.

The use of corona treated polyester film ensures that the present invention can be used to produce the metalized corrugated product as the base corrugated material exits a set of corrugation rollers. Metalization of such a corrugated product can cause additional complications in the glue or adhesive used to unite the liner and the paper sheet together, in combination with heat generated through corrugation, which is solved by the use of the corona treated polyester film.

With the applicant's invention, the addition of corona treated polyester film on one side and corona treated on the opposite side of the liner eliminates these concerns. The liner may be applied while or immediately subsequent to the emergence of the corrugated paper sheet from a set of corrugation rollers.

The applicant has determined that by corona treating one side of the polyester film of the liner applied to the corrugated paper sheet, these heat problems, including the heat magnification problem, are alleviated.

Furthermore, the applicants have found that the chemically treated polyester film can be used to produce the metalized corrugated product required, as the base corrugated material exits the set of corrugation rollers. Chemically treated polyester film again ensures that heat complications arising from the glue or adhesive used to unite the liner and paper together are solved.

Chemically treated polyester film is normally employed to improve the adhesive and printing qualities of laminated products. However, the applicants have found that this type of chemically treated film also aids in solving the heat problems (including the heat magnification problems) associated with lamination of a base corrugated material as it exits the set of corrugation rollers.

Chemically treating the polyester film changes the surface tension of the plastic film in a similar manner to an etching process.

In a preferred embodiment, the film employed may be chemically treated through having an acrylic base coating applied to it. This acrylic coating gives the film the required characteristics to allow it to function effectively in accordance with some embodiments of the present invention.

The film employed may be chemically treated on one or both sides if required in different embodiments of the present invention.

### BRIEF DESCRIPTION OF THE DRAWINGS

These as well as other features of the present invention will become more apparent upon reference to the drawings wherein:

FIG. 1 shows a schematic side view of apparatus in accordance with the present invention set up to produce a two or three ply laminate.

### DETAILED DESCRIPTION OF THE INVENTION

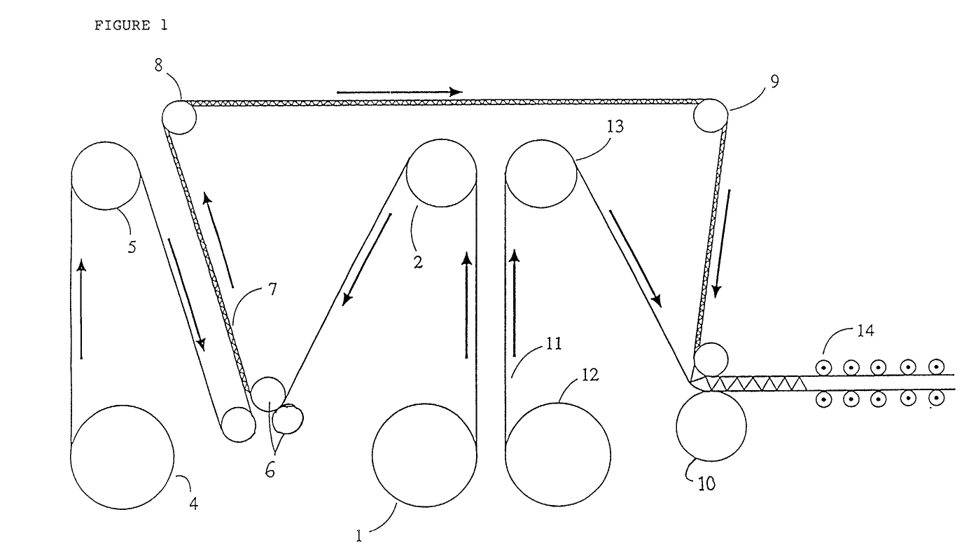

Referring now to the drawings wherein the showings are for purposes of illustrating a preferred embodiment of the present invention only, and not for purposes of limiting the same, FIG. 1 illustrates a schematic side view of apparatus in accordance with the present invention. With respect to the drawing, a roll of paper 1 is threaded over a heating roller 2 and fed to corrugating rollers 6. Simultaneously, a liner material is fed from a roll 4 over a pre-heating roller 5 to the corrugating rollers 6 and laminated to one side of corrugated laminar 7. As can be appreciated by those skilled in the art, the liner is united with the paper 1 as the paper is corrugated and exits the corrugation rollers 6. The laminar is next fed via rollers 8, 9 to nip rollers 10, where (optionally) a liner 11 from a roll 12 is fed via pre-heating roller 13 to the nip rollers 10 to provide a lining to the other side of the laminar.

A cluster of crushing and heating rollers 14 are positioned downstream of the nip rollers 10 through which the completed laminar is fed. Downstream of the lamination apparatus, the completed laminate is stored and cured prior to cutting into box blanks. Containers can be erected from the box blanks.

The paper 1 can be selected from a range of craft and recycled papers. The liner film has high gas barrier properties, high reflectivity to light and radiant heat, low permeability to gases and water vapor, is attractive and decorative, exhibits good abrasion resistance and can be characterized or specified as:

1. Thickness, 12 Micron

2. Tensile strength, 29 kg/mm²

3. Tear strength 7 MD

4. Coefficient of friction 0.6 (film to film)

5. WVTR g/m²/24 hr=2.0

The process of laminating the polyester laminate to any of the craft liners is a reel to reel process using PVA adhesive, applied at normal room temperature at approximately 70 meters per minute.

These reels of paper are delivered to the corrugator for loading one or two liners and one laminar.

The metalized side of the craft liner can be threaded over the pre-heaters with the metalized side facing outwards or inwards (this avoids any likelihood of scuffing the metalized surface). Care must be taken to avoid scuffing if the inwards method is used.

An ideal corrugating speed is between 90 and 120 meters per minute.

At normal corrugating temperatures (130-160° C.) the board, because of the metalized exterior, retains heat for some time, during which time care must be taken when handling the product.

The converting process (making of a finished box) cannot take place until 24 hours after corrugating. This time is necessary for the curing process (i.e., cooling of the board and the moisture balance to finalize).

Whilst it has been known to laminate sheet material such as cardboard with plastics film in the past, this has never been done using a corrugator. Despite advice to the contrary, our process has made this possible, the key factor, we believe, being the pre-made liner material, a laminate of polyester metalized film and a light paper backing. The paper backing resists stretching and minimizes the distribution of heat during the laminating process.

Table 1 shows the physical properties of two different types of chemically treated metalized polyester film. The first product is a one-side metalized polyester film which is chemically treated on both sides and is marketed by Rexam Metallising of Australia under the trade mark Melinex 845™. The second product shown is a metalized polyester film, which is chemically treated only on the unmetalized side of the film. This product is manufactured by Rexam Metallising of Australia under the product name Melinex 813™.

TABLE 1

| PHYSICAL | | | |
|---|---|---|---|
| PROPERTIES | UNITS | MELINEX 845 | MELINEX 813 |
| THICKNESS | microns | 12 | 12 |
| BASIS WEIGHT | g/m² | 16.8 | 16.8 |
| TENSILE | kg/mm² | 20 | >17.5 |
| STRENGTH | | 26 | >17.5 |
| BREAKING | % | 125 | 125 |
| ELONGATION | | 80 | 80 |
| COF | — | 0.50 | 0.50 |
| METAL BOND | g/25 mm | >600 | |
| | | destructive | |
| | | bond | |
| OPTICAL | — | 2.2-2.3 | 2.2-2.3 |
| DENSITY | | | |
| OXYGEN | cc/m²/day | <1.0 | 0.5 |
| TRANSMISSION | | | |
| 23° C. & 50% RH | | | |
| MOISTURE | g/m²/day | <1.0 | 0.5 |
| TRANSMISSION | | | |
| 38° C. & 90% RH | | | |

Table 2 shows the physical properties of two further different types of chemically treated polyester film. Both of these films are manufactured by Saehan Industries of South Korea. The first of these products, MP-531, is a metalized polyester film, while the second of these products, XP-131, is the base chemically treated polyester film material used in MP-531 before metalization.

TABLE 2

| PROPERTIES | UNITS | MP-531 | XP131 |
|---|---|---|---|
| THICKNESS | μm | 12.02 | 16 |
| TENSILE | kg/mm² | 25.9 | 26 |
| STRENGTH, MD | | | |
| TENSILE | % | 26.0 | 25 |
| STRENGTH, TD | | | |
| ELONGATION AT | % | 137 | 135 |
| BREAK, MD | | | |
| ELONGATION AT | % | 142 | 135 |
| BREAK, TD | | | |
| HEAT | % | 1.50 | 1.4 |
| SHRINKAGE, MD | | | |
| HAZE | % | 3.8 | 3.8 |
| TOTAL | % | 89.9 | 89.6 |
| LUMINOUS | | | |
| TRANSMISSION | | | |

Aspects of the present invention have been described by way of example only, and it should be appreciated that modifications and additions may be made thereto without departing from the scope thereof as defined in the appended claims.

1. A method of forming a laminated material comprising the steps of corrugating a paper sheet while applying a liner to at least one side of the corrugated paper sheet, said liner being a pre-made laminate of a paper backing and a polyester film having a first side which is metalized and a second side which is corona treated.

2. The method of claim 1 wherein the polyester film is a biaxially oriented metalized polyester film.

3. The method of claim 1 wherein the liner is preheated prior to its application to the paper sheet.

4. The method of claim 1 wherein the liner is heated by heating rollers and adhered to the paper sheet using a corrugation adhesive.

5. The method of claim 1 wherein the liner is laminated to one side of the paper sheet as the paper sheet is fed from a series of corrugating rollers.

6. A method of forming a laminated material comprising the steps of corrugating a paper sheet while applying a liner to at least one side of the corrugated paper sheet, said liner being a pre-made laminate of a paper backing and a polyester film having a first side which is metalized and a second side which is chemically treated.

7. The method of claim 6 wherein the polyester film is a biaxially oriented metalized polyester film.

8. The method of claim 6 wherein the liner is preheated prior to its application to the paper sheet.

9. The method of claim 6 wherein the liner is heated by heating rollers and adhered to the paper sheet using a corrugation adhesive.

10. The method of claim 6 wherein the liner is laminated to one side of the paper sheet as the paper sheet is fed from a series of corrugating rollers.
